(19) United States
(12) Patent Application Publication
(10) Pub. No.: US 2023/0157281 A1
(43) Pub. Date: May 25, 2023

(54) COMPOSITIONS AND METHODS FOR REPELLING ANIMALS FROM AN OBJECT

(71) Applicant: Texas Tech University System, Lubbock, TX (US)

(72) Inventor: John J. McGlone, Lubbock, TX (US)

(73) Assignee: Texas Tech University System, Lubbock, TX (US)

(21) Appl. No.: 17/908,497

(22) PCT Filed: Mar. 24, 2021
(86) PCT No.: PCT/US2021/023934

§ 371 Date: Aug. 31, 2022

Related U.S. Application Data
(60) Provisional application No. 62/993,969, filed on Mar. 24, 2020.

(51) Int. Cl. A01N 37/06; A01P 17/00

(52) U.S. Cl. CPC A01N 37/06; A01P 17/00

(57) ABSTRACT

In an embodiment, the present disclosure pertains to a method of repelling an animal from an object by applying a composition to the object. In some embodiments, the animal is from the felidae species. In some embodiments, the composition includes butanoic acid and 3-Mercapto-3-Methyl Butanol (MMB). In an additional embodiment, the present disclosure pertains to a composition for repelling an animal from an object. In some embodiments, the animal is from the felidae species. In some embodiments, the composition includes butanoic acid and MMB.

### CROSS-REFERENCE TO RELATED APPLICATIONS

This application claims priority to U.S. Provisional Patent Application No. 62/993,969, filed on Mar. 24, 2020. The entirety of the aforementioned application is incorporated herein by reference.

### BACKGROUND

There are millions of cats in homes that run free. Cats can cause problems by soiling in inappropriate places and scratching various objects. Other animals cause similar problems. Various embodiments of the present disclosure seek to address the aforementioned behaviors.

### SUMMARY

In an embodiment, the present disclosure pertains to a method of repelling an animal from an object. In some embodiments, the animal is from the felidae species. In general, the method includes applying a composition to the object. In some embodiments, the composition includes butanoic acid and 3-Mercapto-3-Methyl Butanol (MMB).

In an additional embodiment, the present disclosure pertains to a composition for repelling an animal from an object. In some embodiments, the animal is from the felidae species. In some embodiments, the composition includes butanoic acid and MMB.

### DESCRIPTION OF THE DRAWINGS

FIG. 1 depicts a method of repelling an animal according to an aspect of the present disclosure.

FIG. 2 illustrates two cardboard standing scratchers with hang socks treated with a control or volatile-containing solution. The scratchers had a square wood base measured at 44 cm×44 cm and an attached round standing column (77 cm in height×13 cm in diameter) that contained a center square wood stick (5 cm×5 cm) covered with round stacked cardboard. One centimeter height of the cardboard column contained four pieces of the stacked cardboard.

FIGS. 3A and 3B illustrate representative chromatogram of volatiles in the urine of male (FIG. 3B) and female (FIG. 3A) cats. Letters a to f correspond to the candidate molecules in Table 2 (Std: standard).

FIGS. 4A and 4B illustrate representative chromatograms of volatiles in the feces of female (FIG. 4A) and male (FIG. 4B) cats. Letters a to t correspond to the candidate molecules in Table 4 (Std: standard).

FIG. 5 illustrates the effects of treatment solution, mix of butanoic acid and 3-Mercapto-3-Methyl Butanol (MMB) dissolved in mineral oil, and a control solution (mineral oil) on the behavioral measurements obtained from the standing cardboard scratchers in adult household cats (N=28 cats; #, **: Least squares means differed between treatment groups at P<0.10 and P<0.01 based on the Wilcoxon signed rank test).

FIG. 6 illustrates the effects of the interaction between sex, female (F, N=7), male (M, N=7), spayed female (SF, N=7), and neutered male (NM, N=7), and treatment (i.e., control versus volatile-treated standing cardboard scratcher) on the back-transformed preference index (PI) of interaction duration (a, b, c, d: Least squares means of arcsine square root transformed data differed within each measurement with different letters).

### DETAILED DESCRIPTION

It is to be understood that both the foregoing general description and the following detailed description are illustrative and explanatory, and are not restrictive of the subject matter, as claimed. In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” encompass both elements or components comprising one unit and elements or components that include more than one unit unless specifically stated otherwise.

The section headings used herein are for organizational purposes and are not to be construed as limiting the subject matter described. All documents, or portions of documents, cited in this application, including, but not limited to, patents, patent applications, articles, books, and treatises, are hereby expressly incorporated herein by reference in their entirety for any purpose. In the event that one or more of the incorporated literature and similar materials defines a term in a manner that contradicts the definition of that term in this application, this application controls.

Cats rely heavily on the olfactory communications for individual identity, territory marking, reproduction, alarm, and maternal recognition. Various candidate pheromones have been reported in cats. The facial pheromones, mammary appeasing pheromones, and the pedal interdigital pheromones have been studied and applied to solve behavioral problems in cats. However, less work has been done on the identification and application of potential pheromones and semiochemicals from cat urine and feces.

Studies evaluating the cat urinary and fecal components as behavioral modifiers are limited. Organic cat urine extracts were reported by one study to attract both cats and bobcats, and induced sniffing and the flehmen response in cats. It was reported that the use of I-felinine in litter attracts cats to eliminate in the litter box, but others disagreed and reported that the major felinine metabolite, 3-Mercapto-3-Methyl Butanol (MMB), did not increase the use of litter box in cats.

Scratching, as a natural behavior for cats, serves the purpose of nail polishing, extension of the hind limbs, and providing visual and chemical signals for conspecific communications. When the scratching behavior is exhibited indoor on furniture, it is often considered as problematic by the owners and referred to as inappropriate scratching. Moreover, there are currently very limited compositions to deter or repel cats as well as other animals from particular areas or objects.

Accordingly, a need exists for more effective methods and compositions for repelling animals from objects. Various embodiments of the present disclosure address the aforementioned need.

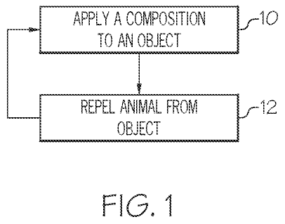

In some embodiments, the present disclosure pertains to methods of repelling an animal (e.g., a felidae species) from an object. In some embodiments illustrated in FIG. 1, the methods of the present disclosure generally include a step of applying a composition to an object (step 10), thereby repelling the animal from the object (step 12). In some embodiments, the composition includes butanoic acid and 3-Mercapto-3-Methyl Butanol (MMB). In some embodiments, the methods of the present disclosure can be repeated on the same or different objects. Additional embodiments of the present disclosure pertain to compositions to repel animals.

As set forth in more detail herein, the methods and compositions of the present disclosure can have numerous embodiments. For instance, the methods of the present disclosure can include application of various compositions to various objects to repel various animals from the object. In addition, various application methods can be utilized to apply the compositions to the objects. Moreover, the methods of the present disclosure can identify repelling of an animal from the object through numerous identifying actions or behaviors.

Furthermore, the methods of the present disclosure can utilize compositions having different forms and components (e.g., 3-Mercapto-3-Methyl Butanol (MMB) and butanoic acid), with the components having varying concentrations. In addition, the compositions utilized in the methods disclosed herein can include further components, such as, but not limited to, carriers and deodorizers. Various embodiments of the present disclosure further pertain to compositions to repel animals from objects.

Methods of Repelling Animals

In general, the methods of repelling an animal from an object include a step of applying a composition to the object. In some embodiments, the composition is composed of butanoic acid and MMB.

Objects

The methods of the present disclosure can include application of the compositions of the present disclosure to various objects to repel an animal from the object. For instance, in some embodiments, the object can include, without limitation, an area, a material, an animal, a human, or combinations thereof.

In some embodiments, the object is an area. In some embodiments, the area can include, without limitation an indoor area, an outdoor area, a room, a closet, a garden, a patio, a yard, or combinations thereof.

In some embodiments, the object is a material. In some embodiments, the material can include, without limitation, an indoor material, an outdoor material, a wall, a scratch pad, furniture, a table, a bookcase, a carpet, a rug, a wall, a curtain, a drape, a door, a tree, a fence, a planter, a pot, or combinations thereof.

In some embodiments, the object is a human. For instance, in some embodiments, the object is the human owner of an animal. As such, in some embodiments, the compositions of the present disclosure are applied to the human owner in order to repel the animal from the human owner.

In some embodiments, the object is an animal. For instance, in some embodiments, the object is a prey animal of a predator animal. As such, in some embodiments, the compositions of the present disclosure are applied to the prey animal in order to repel the predator animal from the prey animal. In some embodiments, the predator animal is a felidae species, such as a cat. In some embodiments, the prey animal includes a prey animal of a felidae species. In some embodiments, the prey animal includes, without limitation, rodents, snakes, rabbits, or combinations thereof.

Application

The compositions of the present disclosure may be applied to objects in various manners. For instance, in some embodiments, the applying occurs by a method that can include, without limitation, spraying, incubating, pouring, rubbing, ingesting, or combinations thereof.

In some embodiments, the applying occurs via spraying. In some embodiments, the spraying includes spraying the composition onto the object.

In some embodiments, the applying occurs via incubating. In some embodiments, the incubating can include incubating the composition at or near the object.

In some embodiments, the applying occurs via ingesting. For instance, in some embodiments where the object is an animal or a human, the applying occurs by inducing the animal or the human to ingest the compositions of the present disclosure. In some embodiments, the inducing occurs by associating the compositions of the present disclosure with the food source of the human or animal. In some embodiments, the associating occurs by spraying the compositions of the present disclosure onto the food source. In some embodiments, the associating occurs by embedding the compositions of the present disclosure with the food source.

The methods of the present disclosure may utilize various materials to apply the compositions of the present disclosure to an object. For instance, in some embodiments, the compositions of the present disclosure may be applied to an object through the utilization of a sprayer, a diffuser, an ointment, a collar (e.g., a plastic collar), or a toy.

In some embodiments the compositions of the present disclosure may be applied to a food source, a bedding, or an environment in any manner to allow an animal (e.g., a cat or a prey species) to smell it and react to it. For instance, in some embodiments, the compositions of the present disclosure may be applied to a human food source in order to repel an animal (e.g., a cat) from the food source.

Repelling

The methods and compositions of the present disclosure can repel animals from an object in various manners. For instance, in some embodiments, the repelling is identified by a reduction in scratching frequency of the object over an allotted time, a reduction in scratching duration of the object, a reduction in interaction frequency with the object over an allotted time, a reduction in interaction duration with the object, or combinations thereof. In some embodiments, the repelling is identified by a reduction in scratching frequency of the object over an allotted time, a reduction in scratching duration of the object, or combinations thereof.

In some embodiments, the repelling is identified by a reduction in scratching duration of the object. In some embodiments, the applying reduces scratching duration by at least 10%. In some embodiments, the applying reduces scratching duration by at least 15%. In some embodiments, the applying reduces scratching duration by at least 20%. In some embodiments, the applying reduces scratching duration by at least 25%. In some embodiments, the applying reduces scratching duration by 100%. In some cases, the applying is entirely effective in eliminating scratching.

In some embodiments, the repelling is identified by a reduction in scratching frequency of the object over an allotted time. In some embodiments, scratching is identified by extension of front claws and gripping with the extended claws. In some embodiments, the applying reduces scratching frequency by at least 10%. In some embodiments, the applying reduces scratching frequency by at least 20%. In some embodiments, the applying reduces scratching frequency by at least 30%. In some embodiments, the applying reduces scratching frequency by at least 40%. In some embodiments, the applying reduces scratching frequency by at least 50%. In some embodiments, the applying reduces scratching frequency by up to 100%. In some embodiments, the applying reduces scratching frequency by 100%.

In some embodiments, the repelling is identified by a reduction in interaction frequency with the object over an allotted time. In some embodiments, the repelling is identified by a reduction in interaction duration with the object. In some embodiments, interaction activities can include, without limitation, climbing, rolling, rubbing, kicking, patting, scratching-based interactions, non-scratching-based interactions, interaction with humans, interaction with animals, or combinations thereof.

In some embodiments, the repelling is identified by a reduction in interaction frequency with the object over an allotted time. In some embodiments, the applying reduces interaction frequency by at least 10%. In some embodiments, the applying reduces interaction frequency by at least 20%. In some embodiments, the applying reduces interaction frequency by at least 30%. In some embodiments, the applying reduces interaction frequency by at least 40%. In some embodiments, the applying reduces interaction frequency by at least 40%. In some embodiments, the applying reduces interaction frequency by up to 100%. In some embodiments, the applying reduces interaction frequency by 100%.

In some embodiments, the repelling is identified by a reduction in interaction duration with the object. In some embodiments, the applying reduces interaction duration by at least 10%. In some embodiments, the applying reduces interaction duration by at least 20%. In some embodiments, the applying reduces interaction duration by at least 30%. In some embodiments, the applying reduces interaction duration by at least 40%. In some embodiments, the applying reduces interaction duration by at least 50%. In some embodiments, the applying reduces interaction duration by up to 100%. In some embodiments, the applying reduces interaction duration by 100%.

Animals

The methods of the present disclosure can be utilized to repel various types of animals from objects. For instance, in some embodiments, the animals are from the felidae species. In some embodiments, the animals can include, without limitation, cats, domesticated cats, non-domesticated cats, wild cats, bobcats, tigers, Canada lynxes, servals, cougars, fishing cats, Asian gold cats, ocelots, European wildcats, or combinations thereof. In some embodiments, the animals are cats. In some embodiments, the animals are domesticated cats. In some embodiments, the animals are non-domesticated cats.

In some embodiments, the animals include the prey of felidae species, such as cats. In some embodiments, the animals include, without limitation, rodents, snakes, rabbits, and other prey of felidae species.

Compositions

The methods of the present disclosure can utilize various compositions to repel animals from objects. Additional embodiments of the present disclosure pertain to such compositions. The compositions of the present disclosure generally include butanoic acid and 3-Mercapto Methyl Butanol (MMB).

The compositions of the present disclosure can have different forms. For instance, in some embodiments, the compositions of the present disclosure are in an isolated form. In some embodiments, the isolated compositions are isolated from an animal feces or urine. In some embodiments, the compositions of the present disclosure exclude animal feces or urine but represent one or more of their components (e.g., butanoic acid and 3-Mercapto-3-Methyl Butanol (MMB)). In some embodiments, the compositions of the present disclosure are in a purified form.

In some embodiments, the compositions of the present disclosure are in a liquid form, a gel form, a solid form, a gaseous form, or combinations thereof. In some embodiments, the compositions of the present disclosure are in the form of an aerosol. In some embodiments, the compositions of the present disclosure are in the form of a solid. In some embodiments, the compositions of the present disclosure are in the form of a pellet. In some embodiments, the compositions of the present disclosure are in the form of a liquid. In some embodiments, the compositions of the present disclosure are in the form of a sprayable liquid.

In some embodiments, the compositions of the present disclosure are in the form of a toy, such as a plastic-infused toy. In some embodiments, the compositions of the present disclosure are in the form of a collar, such as a plastic collar. In some embodiments, the compositions of the present disclosure are in the form of a room diffuser. In some embodiments, the compositions of the present disclosure are in the form of an ointment. In some embodiments, the compositions of the present disclosure are in the form of a gel. In some embodiments, the compositions of the present disclosure are in the form of a toothpaste.

In some embodiments, the compositions of the present disclosure are in the form of a sprayer. In some embodiments, the compositions of the present disclosure are in the form of a diffuser. In some embodiments, the compositions of the present disclosure are in the form of an ointment.

In some embodiments, the compositions of the present disclosure are in the form of an emulsion, such as a microemulsion. In some embodiments, the emulsions are prepared by first diluting lipid-soluble molecules in an oil or hydrophobic liquid or gel to form a first solution. In some embodiments, the first solution may be further diluted in a hydrophilic solute, such as water. In some embodiments, the emulsions allow for low-alcohol or low-lipid variations that are not flammable and are more easily shipped.

3-Mercapto-3-Methyl Butanol

The compositions of the present disclosure can include 3-Mercapto-3-Methyl Butanol (MMB) at various concentrations. For instance, in some embodiments, the MMB is present at a concentration of about 0.01 μg/ml to about 100 μg/ml in the composition. In some embodiments, the MMB is present at a concentration of about 0.01 μg/ml to about 50 μg/ml in the composition. In some embodiments, the MMB is present at a concentration of about 1 μg/ml to about 50 μg/ml in the composition. In some embodiments, the MMB is present at a concentration of about 1 μg/ml to about 25 μg/ml in the composition. In some embodiments, the MMB is present at a concentration of about 2 μg/ml to about 11 μg/ml in the composition.

In some embodiments, the MMB is present at a concentration of at least about 0.01 μg/ml in the composition. In some embodiments, the MMB is present at a concentration of at least about 0.1 μg/ml in the composition. In some embodiments, the MMB is present at a concentration of at least about 0.5 μg/ml in the composition. In some embodiments, the MMB is present at a concentration of at least about 1.0 μg/ml in the composition. In some embodiments, the MMB is present at a concentration of at least about 2.0 μg/ml in the composition. In some embodiments, the MMB is present at a concentration of at least about 5.0 μg/ml in the composition. In some embodiments, the MMB is present at a concentration of at least about 10.0 μg/ml in the composition. In some embodiments, the MMB is present at a concentration of at least about 50.0 μg/ml in the composition. In some embodiments, the MMB is present at a concentration of at least about 100.0 μg/ml in the composition.

Butanoic Acid

The compositions of the present disclosure can also include butanoic acid at varying concentrations. For instance, in some embodiments, the butanoic acid is present at a concentration of about 0.01 mg/mL to about 100 mg/mL in the composition. In some embodiments, the butanoic acid is present at a concentration of about 0.01 mg/mL to about 50 mg/mL in the composition. In some embodiments, the butanoic acid is present at a concentration of about 10 mg/mL to about 30 mg/mL in the composition. In some embodiments, the butanoic acid is present at a concentration of about 15 mg/mL to about 30 mg/mL in the composition.

In some embodiments, the butanoic acid is present at a concentration of at least about 0.01 mg/mL in the composition. In some embodiments, the butanoic acid is present at a concentration of at least about 0.1 mg/mL in the composition. In some embodiments, the butanoic acid is present at a concentration of at least about 0.5 mg/mL in the composition. In some embodiments, the butanoic acid is present at a concentration of at least about 1 mg/mL in the composition. In some embodiments, the butanoic acid is present at a concentration of at least about 5 mg/mL in the composition. In some embodiments, the butanoic acid is present at a concentration of at least about 10 mg/mL in the composition.

Carrier

In some embodiments, the compositions of the present disclosure can also include one or more carriers. In some embodiments, the one or more carriers can be utilized to prepare a solution, a microemulsion, or combinations thereof. In some embodiments, the carrier facilitates the release of the butanoic acid and MMB. In some embodiments, the carrier can include, without limitation, hydrophobic solutions, mineral oil, liquid paraffin, vegetable oil, essential oil, organic oil, lipids, or combinations thereof. In some embodiments, the carrier includes mineral oil.

Deodorizer

In some embodiments, the compositions of the present disclosure can also include various deodorizers. In some embodiments, the deodorizers improve or augment the smell of the composition. In some embodiments, the deodorizer reduces or eliminates odor associated with the composition. In some embodiments, the deodorizer is an odor masking agent. In some embodiments, the deodorizer can include, without limitation, lavender extracts, floral extracts, vanilla extracts, glycols, baking soda, vinegar, hydrogen peroxide, chlorine, chlorine-based compounds, or combinations thereof.

Applications and Advantages

The present disclosure can have various advantages. For instance, in some embodiments, the methods and compositions of the present disclosure have at least the following valuable features of: (1) protecting objects, such as, but not limited to furniture, from being scratched by cats; and (2) potential behavior modifying effects in other contexts, such as, but not limited to use of a litter box. In some embodiments, the application of the compositions of the present disclosure to an object, such as a scratcher, reduces the scratching behavior and total interactions exhibited to the object in cats.

As such, the methods and compositions of the present disclosure can be utilized in various manners and for various purposes. For instance, in some embodiments, the methods and compositions as disclosed herein can be utilized to repel an animal from an object. In some embodiments, the animal is from the felidae species. In some embodiments, the methods and compositions of the present disclosure can cause: (1) a reduction in scratching frequency of the object over an allotted time: (2) a reduction in scratching duration of the object; (3) a reduction in interaction frequency with the object over an allotted time; (4) a reduction in interaction duration with the object; and/or (5) a reduction in various combinations of the aforementioned activities.

### Additional Embodiments

Reference will now be made to more specific embodiments of the present disclosure and experimental results that provide support for such embodiments. However, Applicants note that the disclosure below is for illustrative purposes only and is not intended to limit the scope of the claimed subject matter in any way.

### Example 1. Identification and Quantification of Potential Semiochemicals from Cat Urine and Feces and their Effects on Modifying the Use of Scratchers in Cats

This Example describes identification and quantification of potential semiochemicals from cat urine and feces and their effects on modifying the use of scratchers in cats.

Research on the identification and application of potential semiochemicals in the cat urine and feces is limited. Intact adult cats were compared for the sex differences of the volatiles in their urinary (N=7 females, 7 males) and fecal samples (N=8 females, 10 males) using gas chromatography-mass spectrometry (GC-MS). Males had seven times higher concentration of 3-Mercapto-3-Methyl Butanol (MMB, P<0.001) in the urine and 98% higher butanoic acid (P=0.02) in the feces than females. The estimated amount of MMB (0.1 μL) and butanoic acid (100 μL) from one elimination of a male cat was dissolved in one mL of mineral oil (volatile-containing solution), and evaluated for its effectiveness in modifying the use of scratchers in cats, with mineral oil served as the control solution. Two similar cardboard standing scratchers, treated with either the control and volatile-containing solution delivered through hang socks, were placed side by side, and a total of 28 cats interacted individually with the scratchers for 20 mins. Volatile-containing solution significantly decreased scratching duration (21.19 vs 6.08±3.8 s; P<0.0001) and frequency (1.49 vs 0.82±0.3 times; P=0.07), as well as the interaction duration (31.54 vs 12.90±5.9 s; P=0.0001) compared with the control solution based on the Wilcoxon signed rank test. The male-representative mix of MMB and butanoic acid had aversive effects in cats and might have the application in protecting the furniture from the destructive scratching exhibited by household cats.

### Example 1.1. Introduction

Cats rely heavily on the olfactory communications for individual identity, territory marking, reproduction, and alarm and maternal recognition. Candidate pheromones have been reported in cats. The facial pheromones, mammary appeasing pheromones, and the pedal interdigital pheromones have been studied and applied to solve behavioral problems in cats. Less work has been done on the identification and application of potential pheromones/semiochemicals from the cat urine and feces, even though there are some evidences suggesting that odor signals from cat eliminations may conveying individual and/or sex information in conspecific recognition. For example, intact male cats and estrous female cats exhibit urine marking on vertical surfaces; feces were found unburied at the peripheral but not the core areas of their home range. Felinine and its volatile derivatives, including 3-mercapto-3-methyl butanol (MMB) and 3-mercapto-3-methylbutyl formate can be detected in the urine exclusively in cats and some small felids like bobcats and leopards. With a characteristic sulfur odor, MMB is believed to be the male cat sex recognition pheromone because a higher level of MMB exists in the urine of mature male cats than in mature females and castrated males. A recent study reported that feces from intact male adult cats had higher levels of propanoic acid, 4-methyl-pentanoic acid, and MMB than feces from non-estrus intact females. The same volatile fatty acids were also detected at the perianal area and were suggested to serve the purpose of individual but not sex identification in cats. Studies evaluating the cat urinary and fecal components as behavioral modifiers are limited. Organic cat urine extracts were reported by one study to attract both cats and bobcats, and induced sniffing and the flehmen response in cats. It was reported that the use of I-felinine in litter attract cats to eliminate in the litter box, but others disagreed and reported that the major felinine metabolite, MMB did not increase the use of litter box in cats.

Scratching, as a natural behavior for cats serves the purpose of nail polishing, extension of the hind limbs, and providing visual and chemical signals for conspecific communications. When the scratching behavior is exhibited indoor on the furniture, it is often considered as problematic by the owners and referred as inappropriate scratching. A common solution to this problem is to redirect the behavior to scratching devices provided to the environment. Application of pheromone/semiochemicals that can attract or deter cats to scratching devices might change the use of scratchers in cats and potentially assist in reducing inappropriate scratching. So far, one study reported that a commercial product FELISCRATCH by Feliway™, containing analogue of chemicals secreted from cat interdigital area and extraction of catnip, induced more scratching behavior in cats when been applied to laying cardboard scratcher. This Example identified and quantified the major volatile compounds from cat urine and feces that differed between intact adult male and female cats, and investigated the effects of these molecules on the use of scratchers in cats.

### Example 1.2. Methods and Materials

Animals. All research was approved by the Texas Tech University Institutional Animal Care and Use Committee. Cats included in the study were recruited from owners and a local shelter. Ten intact male and eight intact anestrous female adult cats (≥1 yr of age) were included for sample collection. Cats were housed individually in kennels measured 90 cm×65 cm×75 cm with segregated areas for defecation, feeding and resting. They were fed the same diet (Hill's, Science Diet Optimal Care™, premium natural cat food, Chicken Recipe) for at least three weeks before sample collection. Seven intact male and female cats from the shelter (the same cats as included for sample collection) and seven castrated male and female household cats were included for the behavioral assay.

Sample Collection. Samples were collect in December and none of the female cats showed signs of being in heat (e.g., increased frequency of calling, lordosis and other sexual behaviors; Beaver 1992). Unscented nonabsorbent litter (Petconfirm, Nancy Ridge Technology Center, CA) was used for urine collection. Fecal samples were collected either from the litter box or with the free-catching method. The researcher checked the litterbox every 30 minutes during the day (from 8:00 am to 6:30 pm) for urine and feces. The potentially contaminated samples were discarded. Urine was collected with centrifuge tubes (Conical Centrifuge Tubes, Falcon®, USA) and fecal samples with whirl-pack bags (Sigma-Aldrich, U.S.A). Samples were then placed on ice, transferred to the lab and stored in −80° C.

Urine and Feces Extraction. Urine samples were thawed at room temperature and added NaCl till saturation to precipitate urinary proteins. The urine was then vortexed and centrifuged at 3000 rpm, 15 C.° for 10 minutes. The supernatant was filtered with a 0.2 μm cellulose Acetate (CA) syringe filter (Whatman, GE Healthcare, UK) and 9 mL of the filtered urine was added to 1 mL of internal standard, 200 ppm 4-ethyl phenol (97%) diluted in ddH2O. The 10 mL mix was then vortexed and filtered through a reversed phase HyperSep C18 SPE cartridge (2 g bed weight; 40-60 μm particle size; 60 Å pore size; 15 mL column capacity; Thermo Fisher Scientific, Bellefonte, Pa.) at a steady rate of around 0.25 mL/sec using a 12-valve vacuum manifold (Thermo Fisher Scientific, Bellefonte, Pa.). The cartridge was previously conditioned with 10 mL of acetonitrile and then with 10 mL of water. After the filtration, the cartridge was washed with 10 mL water, and centrifuged at 3000 rpm, 15 C.° for 3 minutes to remove the extra water. The cartridge was subsequently eluted with 2 mL acetonitrile to a clean centrifuge tube. Each of 0.1 g NaCl and MgSO₄ was added to the eluted sample to separate the aqueous layer. After 15 minutes, the upper layer was carefully transferred to a 2 mL screw-capped Gas Chromatography (GC)-vial for chemical analysis (Thermo Fisher Scientific, Bellefonte, Pa.).

Two grams of frozen feces was placed in a centrifuge tube, and added 0.5 μL of heptanoic acid (>99%) as the internal standard. Sample was mixed with 5 mL of acetonitrile and vortexed for one minute. The sample was then centrifuged at 3,000 rpm, 15 C.° for 10 minutes. Once centrifuged, the supernatant was filtered with a polytetrafluoroethylene (PTFE) 0.2 μm syringe filter (VWR North America, Denver, Colo.). Each of 0.1 g NaCl and MgSO₄ was added to the filtered solution to separate the aqueous layer. After 15 minutes, the upper layer was carefully transferred to a GC-vial for chemical analysis.

Gas Chromatography-Mass Spectrometry (GC-MS) Conditions. Compounds of interest were identified by matching the obtained mass spectra with a reference library in the instrument control software. The identities of peaks of interest were further confirmed by comparing the mass spectra and retention time with analytical standards.

The fecal and urinary extracts were analyzed using GC-MS (Thermo Trace GC-MS Ultra, Thermo Fisher Scientific Inc., San Jose, Calif.; Split/Splitless injection with ISQ Quadrupole Mass Spectrometry detector) that was equipped with an SPB-PUFA capillary column (30 m length×0.25 mm i.d.×0.20 μm; Sigma-Aldrich, U.S.A) with poly alkylene glycol-bonded stationary phase. One microliter of the sample was injected by an auto sampler in splitless mode into the injection port that was pre-heated to 250° C. Helium was the carrier gas and flowed at 1.2 mL/min. The temperature program of the oven was as follow: 100° C. for 2 min, then increase by 7° C./min to 210° C., and then held at 220° C. for 15 min. The temperature of the mass spectrometer ion source was 225° C. during analysis. Mass spectra was recorded in electron-impact (EI) mode at 70 eV with a mass range from 40 to 450 amu. Compounds of interest were identified by matching the obtained mass spectra with the library data of the instrument control software. The mass spectra and retention time of analytical standards run on the same protocol, was applied to further quantify and qualify the compounds of interest.

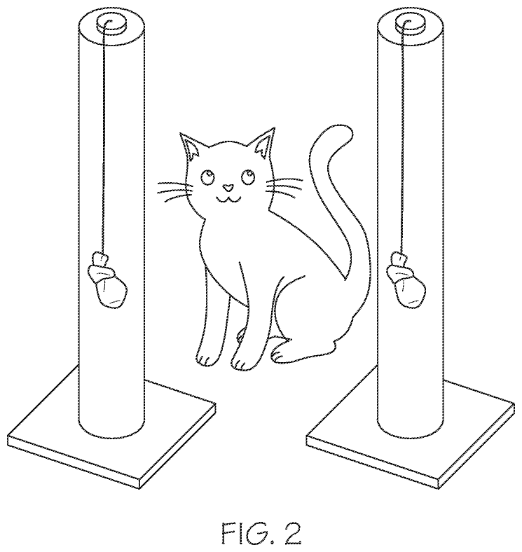

Behavioral Assay. The experimental room was the playing room at the shelter that measured 4.39 m×3.63 m and served the purpose of allowing interaction between the visitors and cats. The room had a standing bookcase, a table, a cat tree and some toys, which were removed from the testing area during the trials. Two socks rinsed either with the placebo or the volatile-containing solution, were hang on two identical cardboard standing scratchers separately. The two scratchers were placed side by side in the room and switched sides between each trials (FIG. 2). A camera (LINNSE, Camcorder Full HD) was set in front of the scratchers to video-tape the trials. Cats were introduced to the experimental room one at a time and they were given 20 minutes to interact with the scratchers. A single trained personnel watched the videos, and recorded how long (duration) and how often (frequency) scratching and interactions occurred between the cats and the scratchers over the experimental period. The videos were watched using fast-forwarding at ×5 to capture times of each burst of interactions between each cat and the scratchers. Each video segment was then watched in detail with continuous sampling in real time. The definitions of scratching and interactions are shown in Table 1. The interactions mentioned in the current Example referred to the total interactions, which included scratching and other non-scratching interactions. Since the volatiles were delivered with socks, interaction with the sock (i.e., licking, pawing, and rubbing against the sock) was also included in the interaction between the cat and the scratchers.

TABLE 1
Behavioral measures of the interactions
between a cat and a scratcher.

| Behavior | Definition |
|---|---|
| Scratching | With front claws extended, cat gripping the material, |
| | and its claws withdraw and extend alternately |
| Interaction | Other active behaviors exhibited on the scratcher, |
| not scratching | including climbing on the scratcher; rolling and |
| | rubbing against the scratcher; scratching the edge of |
| | the base board of the standing scratcher; kicking or |
| | patting the scratcher while being alone or interacting |
| | with other members in the house |
| Total interaction | Sum of scratching and non-scratching interactions |
| Preference Index | PI of specific measurement was calculated as the |
| (PI) | measurement of one scratcher divided by the |
| | measurement summed for both control and treated |
| | scratchers |

Statistical Analysis. All statistical analysis was conducted in SAS 9.4 (SAS Inst., Inc., Cary, N.C.). Peak areas of volatiles from the chemical analysis were calculated using Qual Browser within Xcalibur (Thermo Fisher Scientific Inc., Waltham, Mass.). To be included in the final analysis, the molecule was required to be present in all individuals in one treatment group (i.e., one sex) but not exist in the litter used for sample collection. An area ratio for individual peak was calculated as the peak area of the interested molecule divided by the peak area of the internal standard. Data of peak area ratio were examined for parametric analysis using Shapiro-Wilks and Levene's test. Data that met the assumption for normality was analyzed using the student t-test and the degree of freedom was adjusted with Satterthwaite approximation if the assumption of equal variance was not met. Wilcoxon rank sum test with normal approximation was applied to analyze the data when assumption of normality was not met. Treatment (i.e., sex) effect was considered significant at P≤0.05. Standard solutions with different concentrations of analytical standards and the corresponding peak areas were used to construct the calibration curves for calculating the concentrations of the interested compounds in samples.

For the behavioral assay, duration and frequency of scratching and interactions between the cats and the scratchers was recorded. Assumptions of parametrical analyses were not met based on the Shapiro-Wilks test and Levene's test, therefore data were analyzed with the Wilcoxon signed rank test. Preference index (PI) of specific measurement was calculated as the measurement of one scratcher divided by the measurement summed for both control and treated scratchers. The PI data were then transformed using the arcsine square root transformation and analyzed as repeated measures using GLIMMIX. The model included cat sex and treatment (TRT) and the interaction between sex and treatment (sex*TRT) with cat as random effect. Significant differences were considered at P<0.05 and a tendency at 0.05<P≤0.10.

### Example 1.3. Results

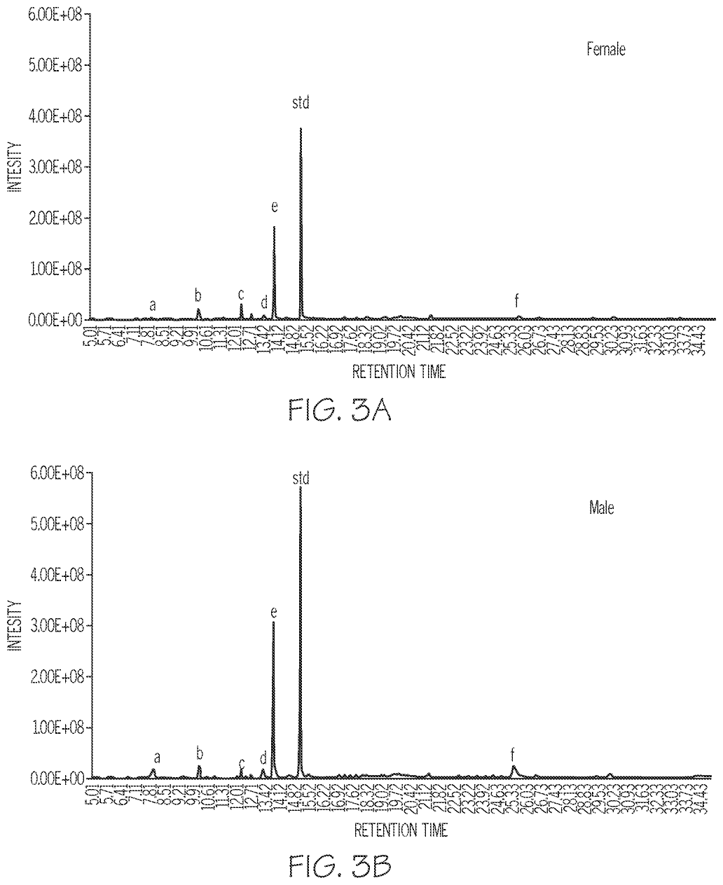

Urine. Six volatiles were identified in the urine of both intact male (FIG. 3B) and female (FIG. 3A) cats (Table 2). When the peak area ratio of these volatiles were compared between sex, male cats had higher 3-mercapto-3-methyl butanol (MMB, P=0.02) and 4-heptanol, 2, 6-dimethyl (P=0.05) in their urine than the female urine (Table 3).

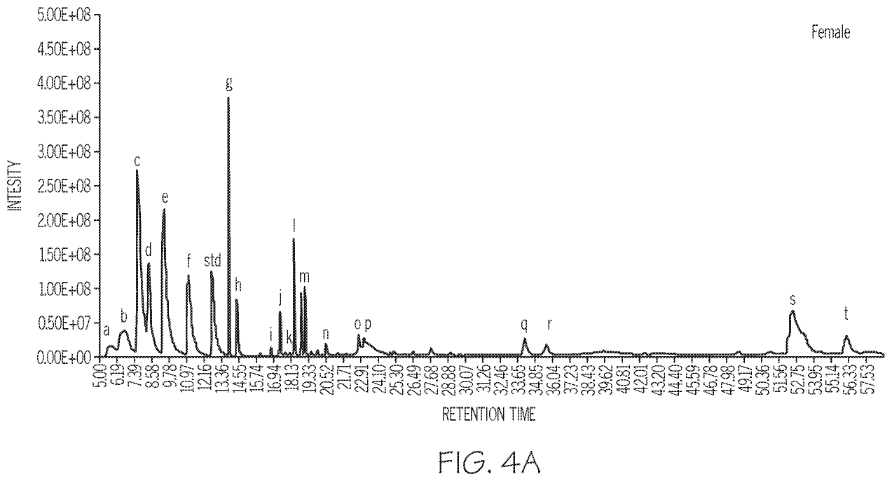

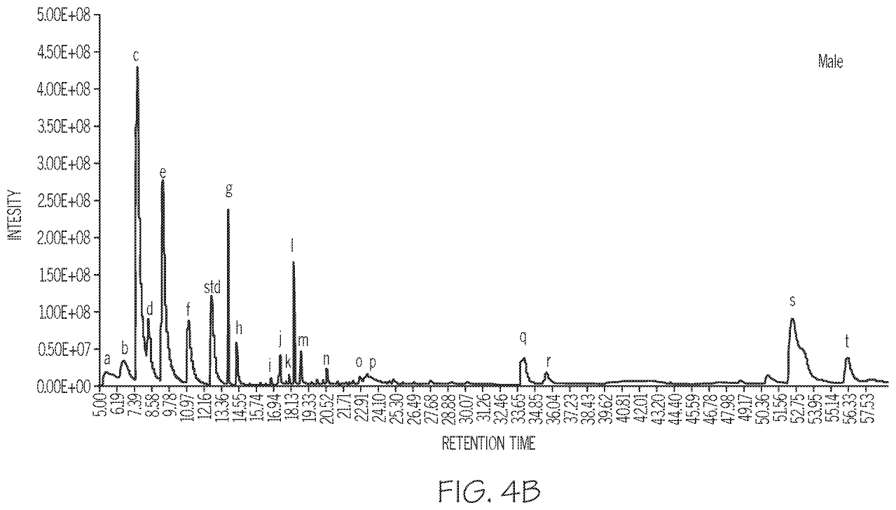

Feces. Twenty major volatiles were identified in the feces of both intact male (FIG. 4B) and female (FIG. 4A) cats (Table 4). When the peak area ratio of these volatiles were compared between sex, male cats had higher butanoic acid (P=0.04) and lower 9-octadecenoic acid (Z)-ethyl ester (P=0.03) in their feces compared to female cats (Table 5).

Of the four volatiles differed in the urine and feces between male and female cats, MMB (the recognized male sex pheromone) and butanoic acid (abundant in the feces) were selected for further analysis, while the other two molecules were not selected because their identities were not able to be verified by the corresponding analytical standards. Concentrations of MMB and butanoic acid in the prepared samples were calculated based on calibration curves (R²≥0.99) made from their analytical standards. Then the concentrations of MMB and butanoic acid (corrected for the fecal dry matter content) in the urinary and fecal samples were estimated and compared for differences between sexes. Both MMB and butanoic acid were in higher (P<0.05) concentrations in male samples than in female samples (Table 6).

TABLE 2
Major volatiles in the urine of cats.

| Peak^{a} | RT | Candidate molecules | Formula | m/z^{b} | Matching^{c} |
|---|---|---|---|---|---|
| a | 7.92 | 3-Mercapto-3-Methyl | C₅H₁₂OS | 69 | 92.15% |
| | | Butanol* | | | |
| b | 10.17 | 2-4-Dimethyl- | C₉H₁₀O | 133 | 23.48% |
| | | Benzaldehyde | | | |
| c | 12.24 | Cis-Jasmone | C₁₁H₁₆O | 79 | 43.04% |
| d | 13.33 | 2,3-Dethydropiperidin- | C₅H₇NO | 97 | 49.14% |
| | | 6-one | | | |
| e | 13.82 | P-Cresol/4-Methyl- | C₇H₈O | 107 | 31.30% |
| | | Phenol* | | | |
| f | 25.64 | 4-Heptanol, 2, 6- | C₉H₂₀O | 69 | 35.85% |
| | | Dimethyl | | | |

^{a}Letter match with peaks in FIGS. 3A and 3B
RT = retention time
^{b}Based on peak of molecular mass spectrum
^{c}Matching rate between obtained mass spectrum and NIST library database
*Volatile confirmed with analytical standard

TABLE 3
Peak area ratio of volatiles in the urine of intact male and female cats.

| | Female | Male | | | | |
|---|---|---|---|---|---|---|
| Candidate Molecule | (N = 7) | (N = 7) | SE^{a} | Df ^{b} | Statistics ^{c} | P-valued |
| 3-Mercapto-3-Methyl Butanol | 0.02 | 0.14 | 0.02 | 6 | −3.04 | 0.02 |
| 2-4-Dimethyl-Benzaldehyde | 0.11 | 0.09 | 0.01 | 12 | 0.92 | 0.38 |
| Cis-Jasmone | 0.09 | 0.04 | 0.02 | 7 | 1.42 | 0.19 |
| 2,3-Dethydropiperidin-6-one | 0.06 | 0.08 | 0.02 | 12 | −0.48 | 0.64 |
| P-Cresol/4-Methyl-Phenol | 0.59 | 0.65 | 0.15 | 8 | −0.27 | 0.79 |
| 4-Heptanol, 2,6-Dimethyl | 0.06 | 0.24 | 0.04 | 7 | −2.43 | 0.05 |

^{a}SE, standard error of least square means
^{b} Df, degree of freedom (Satterthwaite approximation was applied when data was not homoscedastic)
^{c,d} Test statistics and the significant level of sex effect based on the student t-test

TABLE 4
Major volatiles in the feces of cats

| Peak^{a} | RT | Candidate molecules | Formula | m/z^{b} | Matching^{c} |
|---|---|---|---|---|---|
| a | 5.5 | Acetic acid* | C₂H₄O₂ | 60 | 57.89% |
| b | 6.5 | Propanoic acid | C₃H₆O₂ | 74 | 34.47% |
| c | 7.59 | Butanoic acid/butyric acid* | C₄H₈O₂ | 60 | 78.24% |
| d | 8.35 | Isovaleric acid/3-methyl-butanoic* acid | C₅H₁₀O₂ | 60 | 69.56% |
| e | 9.32 | Pentanoic acid | C₅H₁₀O₂ | 60 | 46.37% |
| f | 11.13 | Hexonoic acid | C₆H₁₂O₂ | 60 | 80.65% |
| g | 13.82 | P-cresol/4-methyl-phenol* | C₇H₈O | 107 | 30.73% |
| h | 14.39 | 2-Piperidinone | C₅H₉NO | 99 | 76.51% |
| i | 16.71 | 4-Methyl-5-thiazoleethanol | C₆H₉NOS | 112 | 67.16% |
| j | 17.27 | Hexadecanoic acid,ethyl ester | C₁₈H₃₆O₂ | 88 | 22.48% |
| k | 17.98 | Q-Docecalactone | C₁₂H₂₂O | 85 | 40.66% |
| l | 18.3 | 1-H indole | C₈H₇N | 117 | 31.36% |
| m | 18.77 | Hexadecen-1-ol, trans-9- | C₁₆H₃₂O | 55 | 14.35% |
| n | 20.56 | 9-Octadecenoic acid (Z)- ethyl ester | C₂₀H₃₈O₂ | 55 | 14.97% |
| o | 22.73 | Carbonic acid, ethyl octadecyl ester | C₂₁H₄₂O₃ | 91 | 17.64% |
| p | 23.11 | Propanedioic acid, phenol | C₉H₈O₄ | 91 | 35.60% |
| q | 34.11 | Hexadecanoic acid | C₁₆H₃₂O₂ | 55 | 14.35% |
| r | 35.62 | Oleic acid/8-Octadecenoc acid | C₁₈H₃₄O₂ | 55 | 17.54% |
| s | 52.39 | cis-Vaccenic acid | C₁₈H₃₄O₂ | 55 | 16.37% |
| t | 56.24 | Lenoelaidic acid | C₁₈H₃₂O₂ | 67 | 10.89% |

^{a}Letter match peaks in FIGS. 4A and 4B
RT = retention time
^{b}Based on peak of molecular mass spectrum
^{c}Matching between obtained mass spectrum and NIST library database
*Volatile confirmed with analytical standard

TABLE 5
Peak area ratio of volatiles of feces in intact male and female cats.

| | Female | Male | | | |
|---|---|---|---|---|---|
| Candidate Molecule | (N = 8) | (N = 10) | SE^{a} | Statistics^{b} | P-value^{c} |
| Acetic acid [symbol] | 0.40 | 0.52 | 0.07 | −1.07 | 0.14 |
| Propanoic acid | 0.66 | 0.56 | 0.10 | 0.70 | 0.49 |
| Butanoic acid/butyric acid | 2.78 | 4.85 | 0.63 | −2.28 | 0.04 |
| Isovaleric acid/3-methyl-butanoic | 0.93 | 0.68 | 0.10 | 1.76 | 0.10 |
| acid | | | | | |
| Pentanoic acid | 2.40 | 2.81 | 0.43 | −0.61 | 0.55 |
| Hexonoic acid | 1.22 | 0.93 | 0.21 | 0.98 | 0.34 |
| P-cresol/4-methyl-phenol [symbol] | 0.53 | 0.33 | 0.12 | 1.69 | 0.09 |
| 2-Piperidinone [symbol] | 0.25 | 0.20 | 0.05 | 0.62 | 0.53 |
| 4-Methyl-5-thiazoleethanol | 0.02 | 0.02 | 0.00 | 0.86 | 0.40 |
| Hexadecanoic acid, ethyl ester [symbol] | 0.09 | 0.08 | 0.03 | 0.36 | 0.72 |
| Q-Docecalactone [symbol] | 0.01 | 0.02 | 0.00 | −1.95 | 0.05 |
| 1-H indole [symbol] | 0.24 | 0.22 | 0.07 | 0.27 | 0.79 |
| Hexadecen-1-ol, trans-9- [symbol] | 0.16 | 0.12 | 0.04 | 0.89 | 0.37 |
| 9-Octadecenoic acid (z)-athyl ester [symbol] | 0.13 | 0.04 | 0.03 | 2.22 | 0.03 |
| Carbonic acid, ethyl octadecyl ester [symbol] | 0.31 | 0.29 | 0.01 | 0.2 | 0.84 |
| Propanedioic acid, phenol [symbol] | 0.23 | 0.44 | 0.11 | −0.71 | 0.48 |
| Hexadecanoic acid | 0.15 | 0.15 | 0.03 | 0.02 | 0.99 |
| Oleic acid/8-Octadecenoc acid [symbol] | 1.76 | 2.41 | 0.43 | −1.16 | 0.25 |
| cis-Vaccenic acid [symbol] | 0.40 | 0.50 | 0.14 | −0.62 | 0.53 |
| Lenoelaidic acid [symbol] | 0.40 | 0.52 | 0.07 | −1.07 | 0.14 |

^{a}SE, standard error of least square means
^{b,c}Statistics and significance level of sex difference based on the student t-test or Wilcoxon rank sum test [symbol]
Data not meet the assumption for normality and the Wilcoxon rank sum test was used

TABLE 6
Estimated concentration of candidate
molecules in cat urine and feces.

| | Female CI^{a} | Male CI^{a} | | |
|---|---|---|---|---|
| | (MMB: N = 7; | (MMB: N = 7; | | |
| | Butanoic Acid: | Butanoic Acid: | | |
| Molecules | N = 8) | N = 10) | Statistic^{b} | P-value^{c} |
| MMB (μg/mL) | 0.00-1.63 | 2.22-10.99 | 3.18 | <0.001 |
| Butanoic Acid | 5050-18348 | 16271-30090 | 2.70 | 0.02 |
| (μg/g DM) | | | | |

^{a}Lower and upper value of the 95% confidence interval (CI) 264
^{b,c}Statistics and significance level of sex difference based on the student t-test 265
DM: dry matter; MMB: 3-Mercapto-3-Methyl Butanol

Behavioral Assay. The estimated amount of 0.1 μL of MMB and 100 μL of butanoic acid from one elimination of urine and feces of an intact male cat (i.e., approximate 15 ml urine and 5 g dry matter feces), was dissolved in one milliliter of mineral oil, and used as the treatment solution for the behavioral assay. The control solution was one milliliter of mineral oil without volatiles added.

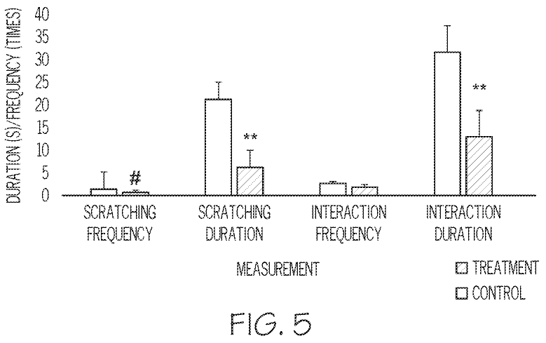

Cats preferred the control scratcher over the volatile-treated scratcher, as indicated by the higher scratching duration (21.19 vs 6.08±3.8 s; P<0.0001) and frequency (1.49 vs 0.82±0.3 times; P=0.07), as well as the duration of interaction (31.54 vs 12.90±5.9 s; P=0.0001) with the control scratcher (FIG. 5).

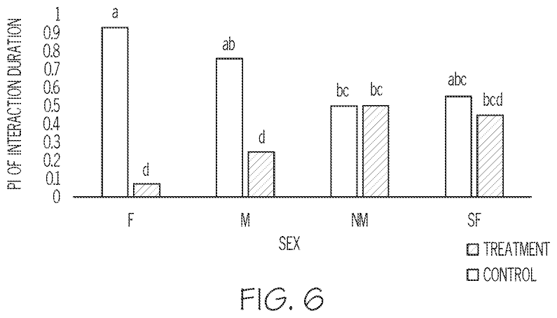

The PIs of the measurements were transformed using the arcsine square root transformation and analyzed for the major treatment effect, and the effect of treatment by sex interaction (TRT*sex; Table 7). Most of the PIs of the control scratcher were higher (P<0.05) than PIs of measures with the treatments scratcher, indicating a preference of the control scratcher. The TRT*sex effect was significant (P=0.03) for the PI of interaction duration, which was higher with the control scratcher than the treatment scratcher in intact (P≤0.05; female, 0.93 vs 0.07; male, 0.76 vs 0.24) but not in castrated cats (P>0.10; spayed female, 0.55 vs 0.45; neutered male, 0.50 vs 0.50, for control and treatment, respectively; FIG. 6).

TABLE 7
The effects of volatiles (i.e., butanoic acid and
MMB) on the use of scratchers based on preference
index of behavioral measurements in adult cats.

| Measurement | | | | |
|---|---|---|---|---|
| preference | Treatment | | P-value^{b} | |
| index (PI)^{a} | Control | Volatile | TRT | TRT* sex |
| Scratching duration PI | 0.63 | 0.10 | 0.0007 | 0.29 |
| Interaction duration PI | 0.70 | 0.30 | 0.002 | 0.03 |
| Scratching frequency PI | 0.56 | 0.14 | 0.006 | 0.14 |
| Interaction frequency PI | 0.90 | 0.09 | 0.08 | 0.08 |

^{a}Reverse-transformed data
^{b}Significant levels of treatment (TRT) effect and treatment by sex interaction (TRT*sex) on the arcsine square root transformed data (N = 28, seven intact and castrated males and females)

### Example 1.4. Discussion

Fewer volatiles were detected in the urine in this Example compared to what has been reported by others. This may be due to the difference between studies in the methodology of sample processing, sensitivity of the instrument, and the criterion used for including the volatiles for further analysis. Regardless, 3-Mercapto-3-Methyl Butanol (MMB) and p-cresol were successfully identified and quantified. The difference in the relative abundance of MMB between intact male and female cats reported here were consistent with those previously reported. Few studies have estimated the concentration of MMB in the cat urine, but MMB was described as having a typical male cat odor at concentrations of 0.01-1 ppm. This is lower than the quantity of MMB estimated by the current Example, 6.60 ppm and 0.81 ppm on average in the urine of intact male and female cat, respectively. All the samples in the current study were collected and transferred to the laboratory on ice, and stored in −80° C. up to a week until analysis. The elapsed time (˜4 hours) between the shelter and laboratory could contribute to the higher MMB concentrations in the current study since cat urine develops an odor peaking in level by ˜12 to 24 hours as felinine being gradually decomposed to MMB. In cats, MMB is originated from the decomposition of a urinary sulphur amino acid, felinine due to the microbial activity and/or oxidation by the air, and a carboxylesterase named cauxin was shown to be involved in the regulation of the felinine production. The excretion rate of felinine in the urine was reported to be 95 mg/day, much higher than intact female cats (19 mg/day). The high excretion rate of felinine requires higher intake of dietary sulphur amino acids in male cats (e.g., cysteine). The main derivative of felinine, MMB may serve as the “honest signal” of predatory skills in the urine of male cats since muscle meat is the main resource for cysteine.

Major volatiles in cat feces identified in the current Example (e.g., short chain fatty acids, P-cresol, indole) were also previously reported. The same study also reported the existence of MMB in the cat feces, which was shown to be also higher in intact males (50 ng/g wet feces) than females. Applicants are not able to verify this finding since the machine was not sensitive enough for the detection of MMB at this low concentration. Previous studies also reported propionic acid and 4-methyl pentanoic acid to be in higher levels in male feces. Applicants' results disagreed with them and found that butanoic acid was 74.5% higher in male feces than in female feces and other fatty acid did not differ between sexes. Cats were able to differentiate the two sets of fatty acids mimicing the ratio of fatty acids in the feces of two different males. This evidence indicates that fatty acids may be involved in individual and sexual identification in cats. A role of volatile fatty acids in olfactory communication is also seen with the cat facial and mammary pheromones, which contain a variety of volatile fatty acids. The concentrations of butanoic acid reported in cat feces in Applicants' Example were slightly higher but close to what others reported, possibly due to the higher starch and fermentable fiber content in the diet for cats of the present Example. The fact that male cats had lower fecal dry matter content compared to females (data not shown) also supported the hypothesis as starch and fermentable fiber increases the stool moisture.

The information conveyed by urine spraying in cats is not completely understood but has been suggested to involve sexual and identity communication, territory/route marking, and stress. Flehmen response is often induced in a cat after it sniffs the urine, especially with the fresh urine of a strange intact male. Urinary extracts of male cats were shown to attract cats and bobcats, and deterred them from urination and defecation in the testing area. Fecal marking is barely studied in cats. Heavier male cats tend to bury the feces closer to the core area than lighter males, indicating that defecating behaviors in male cats may reveal information of social rank. Only a few studies have investigated the application of specific urinary or fecal volatiles in modifying cat behaviors, maybe due to the pungent odor of these volatiles. Applicants reported here the application of volatiles higher in intact male cats, MMB and butanoic acid to the scratcher with the amount estimated from one urination or defecation, reduced the scratching behavior and total interactions exhibited to the scratcher in cats. Other interactions (e.g., sniffing) excluding scratching behavior were not significantly different between the control and treatment groups (data not shown). The result did not agree with the preliminary data from another study, which documented that both male and female cats showed interests to MMB but not to the pure felinine. Information about the dosage of MMB and if MMB also induced flehmen behavior or just increased sniffing in those cats was not detailed. None of the cats in the present Example exhibit flehmen response in the behavioral assay even though they did sniff the treatment during the test. The lack of response may have two explanations: 1) MMB alone was not enough for representing the urine since urine extracts usually contain MMB and other sulphur-containing volatile; and 2) the possible interaction between butanoic acid and MMB blocked the effect of MMB. Testing MMB and butanoic acid separately in the future may verify this hypothesis. One study reported that MMB added to the litter at 50 μg/kg of litter did not alter the use of litterbox in cats. The roles of MMB in contexts other than sexual communication requires further study.

The treatment solution with MMB and butanoic acid was assumed to be perceived by cats as a male urinary and defecating odor during the behavioral assay. Cats scratch in the area they hang out often, along the daily pathway to mark their territory, after sleeping, and near feeding and defecation area. Feral cats scratch more often in the presence of other cats, but cats do not tend to over-mark urinary and fecal marks of other cats. They may scratch near the defecating area but not right on the marks. Cats may also avoid the treated-scratcher to avoid confrontation with other cat and a recent hunting area since feral cats usually live a solitary life during non-breeding season, and they use urine and fecal marks for spacing them apart during hunting and social communication.

In summary, intact male cats had higher MMB and butanioc acid in their urine and feces compared to intact females. The solution containing the estimated amounts of MMB and butanoic acid from one elimination of a male cat had aversive effects on the use of scratchers in cats. The mixed solution of MMB and butanoic acid may have an application in protecting furniture from being scratched by cats and it is worthwhile to investigate its potential behavior-modifying effects in other contexts (e.g., use of litter box). Dietary fiber content and type have great influences on the colon microbial population and the fermented short-chain fatty acids in the feces, it is necessary in the future to investigate the effects of fiber supplementation on the sex difference of fecal volatile fatty acids in cats.

Without further elaboration, it is believed that one skilled in the art can, using the description herein, utilize the present disclosure to its fullest extent. The embodiments described herein are to be construed as illustrative and not as constraining the remainder of the disclosure in any way whatsoever. While the embodiments have been shown and described, many variations and modifications thereof can be made by one skilled in the art without departing from the spirit and teachings of the invention. Accordingly, the scope of protection is not limited by the description set out above, but is only limited by the claims, including all equivalents of the subject matter of the claims. The disclosures of all patents, patent applications and publications cited herein are hereby incorporated herein by reference, to the extent that they provide procedural or other details consistent with and supplementary to those set forth herein.

What is claimed is:

1. A method of repelling an animal from an object, said method comprising:
applying a composition to said object, wherein the composition comprises butanoic acid and 3-Mercapto-3-Methyl Butanol (MMB).

2. The method of claim 1, wherein the object is selected from the group consisting of an area, a material, an animal, a human, or combinations thereof.

3. The method of claim 1, wherein the object comprises an area selected from the group consisting of an indoor area, an outdoor area, a room, a closet, a garden, a patio, a yard, or combinations thereof.

4. (canceled)

5. The method of claim 1, wherein the object comprises a material selected from the group consisting of an indoor material, an outdoor material, a wall, a scratch pad, a furniture, a table, a bookcase, a carpet, a rug, a wall, a curtain, a drape, a door, a tree, a fence, a planter, a pot, or combinations thereof.

6. (canceled)

7. The method of claim 1, wherein the object is a human or an animal.

8. (canceled)

9. The method of claim 1, wherein the object is a prey animal of a predator animal, and wherein the application of the composition to the prey animal repels the predator animal from the prey animal.

10. The method of claim 9, wherein the predator animal is a felidae species, wherein the prey animal is a prey of the felidae species, and wherein the prey animal is selected from the group consisting of rodents, snakes, rabbits, or combinations thereof.

11. (canceled)

12. The method of claim 1, wherein the applying occurs by a method selected from the group consisting of spraying, incubating, pouring, rubbing, ingesting, or combinations thereof.

13. (canceled)

14. (canceled)

15. The method of claim 1, wherein the repelling is identified by a reduction in scratching frequency of the object over an allotted time, a reduction in scratching duration of the object, a reduction in interaction frequency with the object over an allotted time, a reduction in interaction duration with the object, or combinations thereof.

16. (canceled)

17. (canceled)

18. The method of claim 1, wherein the animal comprises a felidae species selected from the group consisting of cats, domesticated cats, non-domesticated cats, wild cats, bobcats, tigers, Canada lynxes, servals, cougars, fishing cats, Asian gold cats, ocelots, European wildcats, or combinations thereof.

19. (canceled)

20. The method of claim 1, wherein the animal is a cat.

21. The method of claim 1, wherein the animal is a prey of a felidae species, wherein the prey of the felidae species is selected from the group consisting of rodents, snakes, rabbits, or combinations thereof.

22. (canceled)

23. The method of claim 1, wherein the composition is in liquid form, gel form, solid form, gaseous form, or combinations thereof.

24. The method of claim 1, wherein the composition is in the form of an aerosol, a solid pellet, a sprayable liquid, an emulsion, or combinations thereof.

25. (canceled)

26. (canceled)

27. (canceled)

28. The method of claim 1, wherein the MMB is at a concentration of about 0.01 μg/ml to about 100 μg/ml in the composition.

29. (canceled)

30. (canceled)

31. The method of claim 1, wherein the butanoic acid is at a concentration of about 0.01 mg/mL to about 100 mg/mL in the composition.

32. (canceled)

33. (canceled)

34. The method of claim 1, wherein the composition further comprises a carrier, wherein the carrier is selected from the group consisting of hydrophobic solutions, mineral oil, liquid paraffin, vegetable oil, essential oil, organic oil, lipids, or combinations thereof.

35. (canceled)

36. (canceled)

37. The method of claim 1, wherein the composition further comprises a deodorizer.

38. The method of claim 37, wherein the deodorizer is an odor masking agent that reduces or eliminates odor associated with the composition.

39. (canceled)

40. The method of claim 37, wherein the deodorizer is selected from the group consisting of lavender extracts, floral extracts, vanilla extracts, glycols, baking soda, vinegar, hydrogen peroxide, chlorine, chlorine-based compounds, or combinations thereof.

41-59. (canceled)
